(19) United States
(12) Patent Application Publication
(10) Pub. No.: US 2002/0172926 A1
(43) Pub. Date: Nov. 21, 2002

(54) Computer-aided learning system and the method of the same

(76) Inventors: Pinky Ma, Beijing (CN); Zechary Chang, Taipei (TW); Sayling Wen, Taipei (TW)

Correspondence Address: BIRCH STEWART KOLASCH & BIRCH, PO BOX 747, FALLS CHURCH, VA, 22040-0747, US

(21) Appl. No.: 09/859,448

(22) Filed: May 18, 2001

(51) Int. Cl. G09B 5/00

(52) U.S. Cl. 434/169; 434/307 R

(57) ABSTRACT

A computer-aided learning system comprising a central processing unit (CPU) and a storage device. The storage device stores a course database including a plurality of course data and a story database including a plurality of story data, with each course datum corresponding to at least one story datum. The CPU runs the following steps of: reading in a course datum from the course database; outputting the course datum to a learner; checking the learner's comprehension of the course material; reading in a story datum from the story database when the learner's comprehension of the course material reaches a certain level and outputting the story datum to the learner; and reading in the next course datum from the course database. The invention also discloses a corresponding computer-aided learning method.

### BACKGROUND OF THE INVENTION

1. Field of Invention

The invention relates to a computer-aided learning system and the method for the same, and, more particularly, to a computer-aided learning system that encourages the learner to develop the desire to continue studying a subject and the method for the same.

2. Related Art

Learners are the subjects to be developed in a learning activity. Generally speaking, before the learner's inner enthusiasm is encouraged, The learner usually goes through an unpleasant process to learn a skill or gain knowledge about a subject. Because of this, without a strong external pressure (such as the encouragement and control of teachers and parents), the learner may give up before learning the requisite knowledge or skill. Once such pessimistic and passive factors are replaced by optimistic and active factors, the learner may become excited and enjoy the learning process and learn more effectively. This will then turn into an everlasting pattern. Therefore, inducing and effectively maintaining the learner's desire to learn and to finish a designated course has been an important subject studied by educators.

Along with development in computer technologies, there are many computer-aided learning systems and methods on the market. However, most of them use the most valuable features of a computer, a large memory capacity and high interactivity, to attract the attention of a learner through a multimedia presentation of the subject. However, the application of multimedia can only help a learner accept the course data but cannot induce interest in the learner to pursue subsequent studies. In other words, they do not fully utilize the technology of the computer to continuously allow the interest of a learner in his subject to grow his and for him to complete a full course of study.

### SUMMARY OF THE INVENTION

Pursuant to the above problems, it is then an objective of the invention to provide a computer-aided learning system and the corresponding method. The invention uses computer technologies to increase the learner's will to continue to learn in order to complete a series of course material.

To achieve the above objective, the disclosed computer-aided learning system includes a central processing unit (CPU) and a storage device. The storage device stores a course database including a plurality of course data and a story database including a plurality of story data, with each course datum corresponding to at least one story datum. The CPU runs the following steps of: reading in a course datum from the course database; outputting the course datum to a learner; checking the learner's comprehension of the course material; reading in a story datum from the story database when the learner's comprehension of the course material reaches a certain level and outputting the story datum to the learner; and reading in the next course datum from the course database.

The invention also discloses a computer-aided learning method implemented in a computer system. This computer system includes a course database storage device storing a plurality of course data and a story database storage device storing a plurality of story data, with some correspondent relationships between the course data and the story data. The method consists of the following steps of: reading in a course datum from the course database; outputting the course datum to a learner; checking the learning effects of the course datum on the learner; and reading in a story datum from the story database when the learner's comprehension of the course material reaches a certain level and outputting the story datum to the learner.

The disclosed system and method can fully utilize computer technologies to continuously interest learners in learning and to complete more courses.

### BRIEF DESCRIPTION OF THE DRAWINGS

The invention will become more fully understood from the detailed description given in the hereinbelow illustration only, and thus are not meant to limit the scope of the invention, and wherein:

FIG. 1 is a schematic view showing the computer-aided learning system structure according to a preferred embodiment of the invention;

FIG. 2 is a schematic view of the course database structure for the computer-aided learning system structure in FIG. 1;

FIG. 3 is a schematic view of the story database structure for the computer-aided learning system structure in FIG. 1;

FIG. 4 is a schematic view of the data structure of the course data/story data correspondence table used in the computer-aided learning system structure in FIG. 1; and

FIG. 5 is a flowchart showing the procedure of the computer-aided learning method according to a preferred embodiment of the invention.

### DETAILED DESCRIPTION OF THE INVENTION

The computer-aided learning system and method of the invention will be apparent from the following detailed description, which proceeds with reference to the accompanying drawings, wherein the same references relate to the same elements.

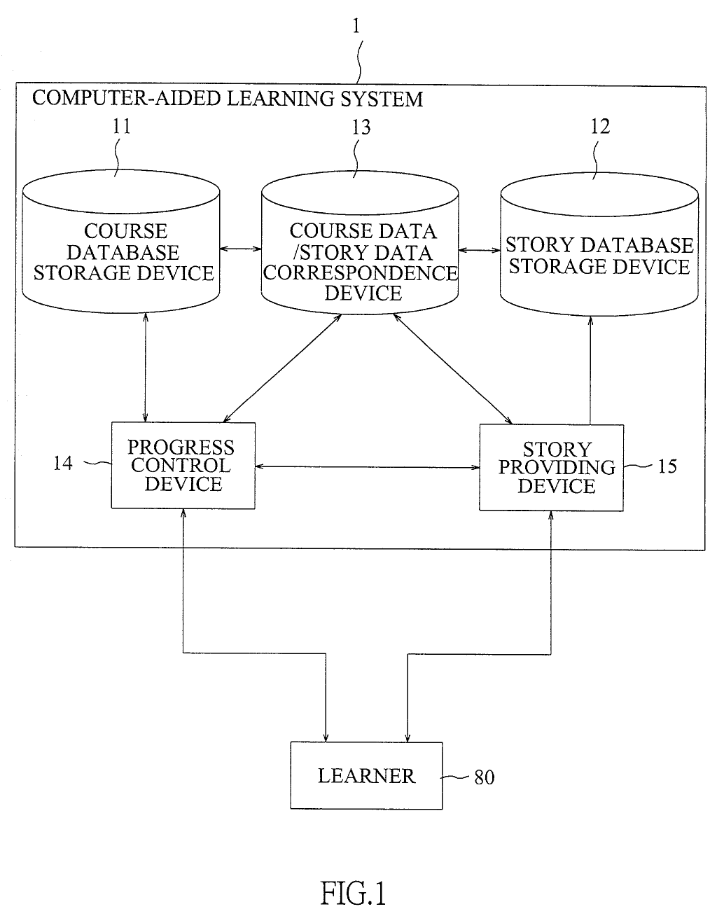

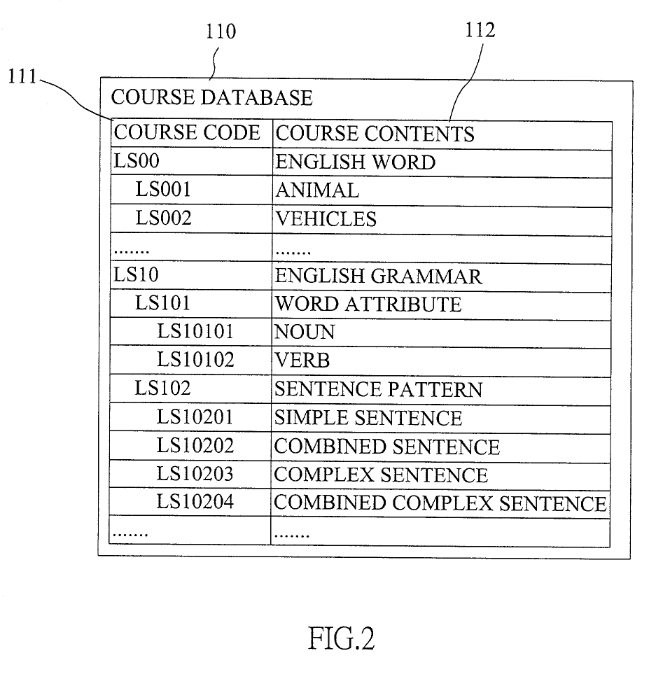

With reference to FIG. 1, the computer-aided learning system 1 according to a preferred embodiment of the invention includes a course database storage device 11, a story database storage device 12, a course data/story data correspondence device 13, a progress control device 14, and a story providing device 15. The course database storage device 11 stores a course database 110 with a plurality of course data. In the current embodiment, the course data refer to English course contents, including the explanation of the meaning of each English word, the grammar structure of English sentences, and text problems designed for such contents. Each course datum has a distinct code, and each word or sentence also has a different code. It should be noted that the course data of the invention are not limited to English course contents, but can be that of any course, such as mathematics or history. Also, the course data are not limited to text contents, but can be text, graphs, animation or sounds. With reference to FIG. 2, each course datum has a course code 111 and at least one course content 112. The course content 112 can be classified according to the practical situation so that all the course data in the course database storage device 11 can form a step-by-step course system. For example, the course content 112 with the course code 111 “LS 101” is an introduction to word attributes and provides the related test problems. The next course content 112 with the course code 111 “LS10101” further explains nouns in the word attributes and provides the corresponding test problems. In such a manner, the learner 80 can learn about English word attributes step by step and evaluate his comprehension of the course material.

Since the course data can be a combination of all sorts of data, any person skilled in the art can make arbitrary and necessary changes to the course contents 112 without departing from the spirit of the invention. For example, if the course code 111 is LS101 and the course contents 112 with the subject of word attributes include more than one file types, the data constructor can build a general file LS101.cnt. The data in LS101.cnt further correspond to LS101.mov, LS101.htm, LS101jpg and LS101.wav files of different types.

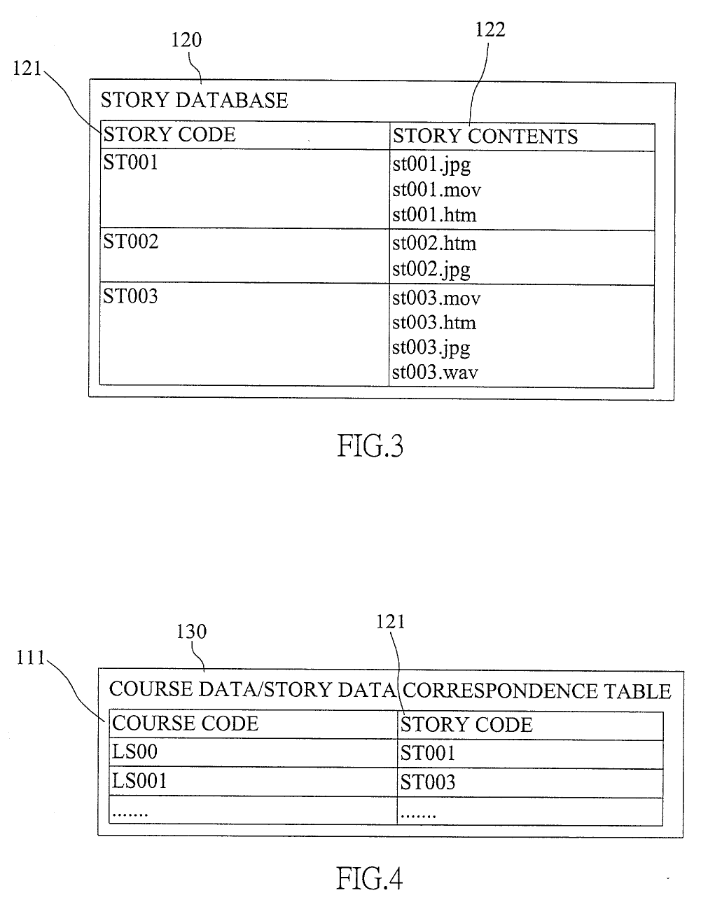

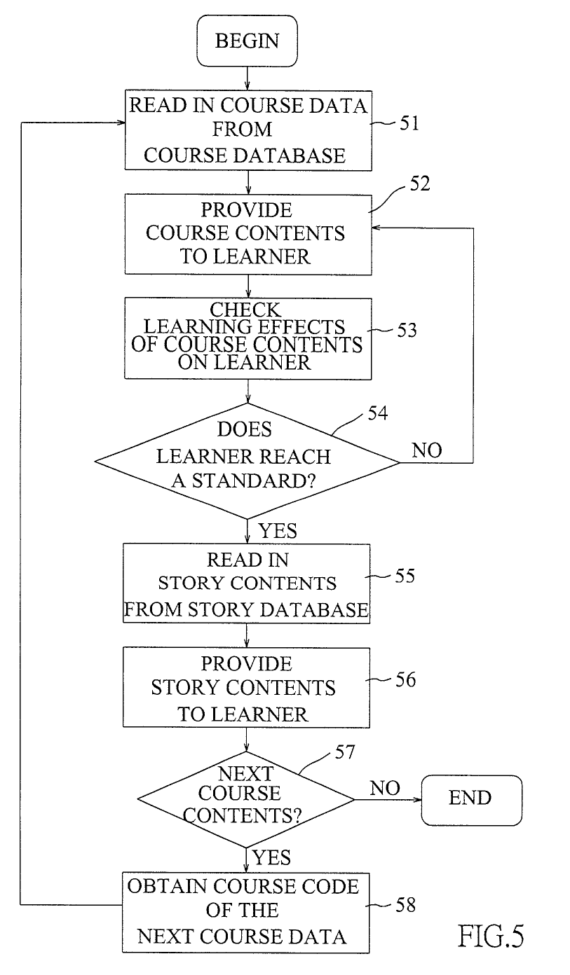

The story database storage device 12 stores a story database 120 including a plurality of story data. With reference to FIG. 3, each story datum in the story database 120 includes a story code 121 and story contents 122. It should be emphasized that the story contents can be text, graphs, animation, or sound and are not limited to a single type. Furthermore, any person skilled in the art can make arbitrary modification to the types in the story contents 122 without departing from the spirit of the invention. For instance, the story contents 122 with the story code 121 ST003 include four different types of files. Therefore, the story contents can be combined to form an st003.sty file. The data in st003.sty correspond to st003.mov, st003.htm, st003.jpg, and st003.wav. The course data/story data correspondence device 13 stores a course data/story data correspondence table 130, recording the correspondence relations between the course data and the story data. Referring to FIG. 5, the course code 111 and the story code 121 in the same column in the course data/story data correspondence table 130 are the course data and story data that are associated with each other.

Please refer to FIG. 5 for an explanation of the detailed procedure for the computer-aided learning method 5 according to a preferred embodiment of the invention.

First, a progress control device 14 reads in a course from a course database 110 in step 51. If this is the first time a learner 80 starts the course, a first course datum is read in from the course database 110 or the learner 80 can select the course data he would like to start with. If the learner had used the system before, he can then continue from the previous course contents.

In step 52, the progress control device 14 provides the course contents 112 to the learner 80. In the current embodiment, the progress control device 14 transmits the course contents 112 to the computer used by the learner through the Internet. The learner 80 can read the course contents 112 from his computer monitor.

In step 53, the progress control device 14 checks the learner's comprehension of the course contents 112. In the embodiment, the progress control device 14 receives the answers to the test problems for the course contents 112 entered by the learner 80 through a keyboard or mouse. It also checks whether the answers are correct to evaluate the learner's progress.

In step 54, if the learner 80 reaches a predetermined level, e.g., more than 80 of the answers are correct, then he can continue to step 55. In step 55, the story providing device 15 obtains a story code 121 corresponding to the course data according to the course content/story content correspondence table 130, and then retrieves the story contents 122 from the story database 120 for the learner 80. For example, if the leaner is studying the course data with the course code LS001, then the story providing device 15 will retrieve the story contents 122 with the story code ST003 from the story database 120 according to the course content/story content correspondence table 130. That is, the files st003.mov, st003.htm, st003.jpg, and st003.wav will be collected to form the complete story contents. Afterwards, the story providing device 15 provides the story contents read into the learner 80 in step 56. Similar to the previously mentioned progress control device 14, the story providing device 15 also transmits the story contents 122, i.e., the image file st003.mov to the computer used by the learner 80 through the Internet. The learner can then read the story contents 122 on his computer monitor.

If the learner selects the next course contents in step 57, the procedure continues to step 58 to read in the course code 111 of the next course datum from the course database. The system then goes to step 51 o read in the course contents according to the course code 111. In step 57, the learner 80 can select whether he wants to continue on to the next course. The progress control device 14 can also determine whether there is a further course of study for the learner to study. If no further course is selected, the learning procedure is ended here.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A computer-aided learning system, comprising:
a course database storage device to store a plurality of course data;
a story database storage device to store a plurality of story data, with specific correspondent relationships between the course data and the story data;
a progress control device, which reads in a course datum from the course database, outputs the course datum to a learner, and checks the learner's comprehension of the course datum; and
a story providing device, which reads in the story datum corresponding to the course datum from the story database storage device when the learner achieves a predetermined level and outputs the story datum to the learner.

2. The system of claim 1, wherein the progress control device further reads in the next course datum and outputs the next course datum to the learner after the progress control device provides the story datum to the learner.

3. The system of claim 1, further comprising:
a course data/story data correspondence device, which stores the correspondent relationships between the course data and the story data,
whereby the story providing device reads in the story datum corresponding to the course datum from the story database storage device.

4. The system of claim 1, wherein the story data are composed of at least one element selected from the group consisting of text, sound, graphs, and animation.

5. A computer-aided learning system comprising a central processing unit (CPU) and a storage device, wherein the storage device stores a course database including a plurality of course data and a story database including a plurality of story data, with certain correspondent relationships between the course data and the story data; the CPU being featured in processing the step of:
reading in a course datum from the course database;
outputting the course datum to a learner;
checking the learner's comprehension of the course material; and
reading in the story datum corresponding to the course datum from the story database storage device when the learner achieves a predetermined level and outputting the story datum to the learner.

6. The system of claim 5, wherein the CPU further processes the step of:
reading in the next course datum from the course database and outputting the next course datum to the learner after outputting the story datum to the learner.

7. The system of claim 5, wherein the storage device further stores a course data/story data correspondence table that includes the correspondent relationships between the course data and the story data, whereby the CPU reads in the story datum corresponding to the course datum from the story database storage device.

8. The system of claim 5, wherein the story data are composed of at least one element selected from the group consisting of text, sound, graph, and animation.

9. The system of claim 5, wherein the storage device is a hard disk drive.

10. The system of claim 5, wherein the storage device is read only memory (ROM).

11. A computer-aided learning method implemented in a computer system comprising a course database storage device including a plurality of course data and a story database storage device including a plurality of story data with certain correspondent relationships in between, wherein the method comprises the steps of:
reading in a course datum from the course database;
outputting the course datum to a learner;
checking the learner's comprehension of the course material; and
reading in the story datum corresponding to the course datum from the story database storage device when the learner achieves a predetermined level and outputting the story datum to the learner.

12. The method of claim 11, further comprising the step of:
reading in the next course datum from the course database and outputting the next course datum to the learner after outputting the story datum to the learner.

13. The method of claim 11, wherein computer system further comprises a course data/story data correspondence device that stores the correspondent relationships between the course data and the story data.

14. The method of claim 11, wherein the story data are composed of at least one element selected from the group consisting of text, sound, graphs, and animation.
